(19) United States
(12) Patent Application Publication
(10) Pub. No.: US 2005/0059834 A1
(43) Pub. Date: Mar. 17, 2005

(54) Dendritic supramolecular compound for electrochemiluminescent analysis

(76) Inventors: Ming Zhou, Ottawa (CA); Jacques Roovers, Ottawa (CA)

Correspondence Address: George A. Seaby;Seaby & Associates, 603 - 880 Wellington Street, Ottawa, ON, K1R 6K7, CA

(21) Appl. No.: 10/940,678

(22) Filed: Sep. 15, 2004

Related U.S. Application Data
(60) Provisional application No. 60/502,986, filed on Sep. 16, 2003.

(51) Int. Cl. C07F 15/00

(52) U.S. Cl. 556/136

(57) ABSTRACT

Dendritic, polynuclear, metal complexes are used as new luminescent labels for immunoassays and DNA probes by means of electrochemiluminescence. The dendritic polynuclear molecules are composed of multiple luminophors which are preferably ruthenium (II) tris(bipyridyl) complexes, [Ru(bpy)₃]²⁺, which define the peripheral or terminal moieties of the dendritic molecules.

### CROSS REFERENCE TO RELATED APPLICATION

This application claims priority on U.S. Provisional Application 60/502,986

### BACKGROUND OF THE INVENTION

1. Field of the Invention

This invention relates to dendritic, supramolecular compounds, and in particular to dendritic polynuclear metal complexes for use as luminescent labels in biochemical and biological electrochemiluminescence analysis.

2. Discussion of the Prior Art

The presence of biochemical and biological substances are often detected and quantified by utilizing the bio-recognition ability, or bio-affinity of biologically active species. Affinity-based bioanalytical assays, such as immunoassay and DNA probing, rely largely on the labeling technique by which signal-generating moieties are linked to some functional groups of biomolecules that can selectively bind to the analytes. For a high signal level in immunoassay, multilabeling at multiple accessible sites (e.g., —NH₂) of a protein molecule is normally practised. However, a high degree of multilabeling may result in the loss of biological activity, high non-specific binding of protein and thus low signal-to-noise. For some monoclonal antibodies, multilabeling may even lead to the precipitation of proteins. One approach to introduce a large number of label molecules at as few sites as possible is to use carrier proteins. However, this approach involves complicated biochemical processes and the carriers themselves are big in size and mass.

Recent progress in dendrimer and supramolecule chemistry provides a new straightforward chemical approach to multilabeling biomolecules at a single site by using dendritic scaffoldings (FIG. 1).

Bard et al disclosed, in U.S. Pat. No. 6,140,138, that ruthenium-or osmium-containing metal complexes may be attached to the amino groups of an analyte of interest. The labeled substances may then be determined by electroluminescence (ECL). The signal-generating units described in this invention are ruthenium (II) tris(bipyridyl) complexes, [Ru(bpy)₃]²⁺, which are used for ECL-based immunoassay and DNA probing. In the current commercial ECL systems, the luminescence signal is generated through a series of electrochemical and chemical reactions. Upon electrochemical oxidation and follow-up chemical reduction by deprotonated tripropylamine radical, [Ru(bpy)₃]²⁺ is excited to a metal-to-ligand charge-transfer (MLCT) state [Ru(bpy)₃]²⁺*, which emits light with wavelength of about 610 nm. The emission intensity is a function of the amount of [Ru(bpy)₃]²⁺ *that is linked to a certain amount of analyte. The detailed principle of ECL of [Ru(bpy)₃]²⁺ is described in detail by several authors (see J. K. Leland et al, J. Electrochem. Soc. 1990, 137, 3127-3131, Y. Zu et al, Anal. Chem. 2000, 72,3223-3232, F. Kanoufi et al, J. Phys. Chem B 2001, 105,210-216, E. M. Gross et al, J. Phys. Chem B 2001, 105, 8732-8738, W. Miao et al, J. Am. Chem Soc. 2002, 124, 14478-14485, and U.S. Pat. Nos. 5,846,485 and 6,316,180). An important feature of the system is the circulation of Ru(bpy)₃²⁺→Ru(bpy)₃³⁺→Ru(bpy)₃²⁺*→Ru(bpy)₃²⁺, which generates signal repeatedly during the measuring period. Measurements based on the emission at 610 nm are rapid, efficient and sensitive. Automated assay systems are now commercially available.

ECL based on other metal complexes have also been studied. Yang et al (see U.S. Pat. No. 5,858,676) discovered that rare earth metal chelates may be greatly advantageous over the ruthenium-containing complexes in terms of signal discrimination, because the emission spectra band widths of rare earth chelates is less than 50 nm, compared with approximately 100 nm for ruthenium system. The Massey et al U.S. Pat. No. 5,811,236 teaches the use of rhenium complexes as ECL labeling compounds. These luminescent systems have a common feature, i.e., they are all monometallic molecules. Although Ru-circulation functions as an amplification process, the observed emission intensity decreases with time rapidly. Thus simply extending measuring time cannot efficiently enhance photo counting and improve detection limit. On the contrary, this may increase signal-to-noise ratio.

The employment of bi-, tri-, and multi-metal complexes, formed by double chelation of the Ru(bpy)₂²⁺ moieties offers the possibility of 2, 3 and multi-photo emitting. However, due to the metal-metal interaction mediated by the bridging-ligand (BL), a decrease or loss of luminescence with respect to the monometallic species was often the result from a number of photophysical studies on the type (ML₂)BLₙ₊ (where ML and BL are metal ligand and bridging-ligand, respectively).

In the past few years, dendrimers based on polynuclear metal complexes have received a great deal of attention, especially those made of photo-and redox-active moieties. Ru(II) complex of polypyridine-type ligands can be used as building blocks to synthesize redox-active and luminescent supramolecular (polynuclear) metal complexes. A particularly convenient method to obtain such supramolecular species is that based on the use of bridging ligand (BL) to connect metal-containing units. Using their “complex as metals and complexes as ligands” synthetic strategy and an iterative protection/deprotection precedure, Balzani et al have prepared polynuclear Ru(II) complexes containing 4, 6, 7, 10, 13 and 22 metal centers. The BL used in their synthesis is 2,3-bis(2-pyridyl)pyrazine and the nonbridging ligand (called terminal ligand, L) present in such supramolecular species is usually 2,2′-bipyridine units.

These dendritic polynuclear metal complexes are good systems for photophysical, photochemical and electrochemical researches. However, each metal unit brings its own redox and luminescent properties, affected by interactions which are particularly noticeable for metals coordinated to the same bridging ligand and for ligands coordinated to the same metal. Redox patterns of these complexes show distinct processes related to central, peripheral and different branching units. In practical ECL application, the accessibility of co-reactants (TPA-derived reducing agent) to the luminophors in the core and branches is very difficult. Under the circumstances, ECL signals can be emitted only from the peripheral luminophors, the emitting efficiency φₑₘ of which, unfortunately, is normally in the range of 10⁻³-10⁻⁵ (compared to 0.059 for Ru(bpy)₃]²⁺) due to the interaction with branch units. Luminescence from these species is much weaker than that of monometallic [Ru(bpy)₃]²⁺. Not only in the metallodendritic system, but also in many simpler bimetallic and multimetallic systems, the emission is weaker, or even much weaker than that observed in the parent monometallic ruthenium complex. This seems to be a general rule.

Exceptions are found in a few bimetallic systems. For example, [(dmb)₂Ru]₂(bbpe)⁴⁺ and [(dmb)₂Ru]₂(bphb)⁴⁺[dmb=4,4′-dimethyl-2,2′-bipyridine, bbpe-trans-1,2-bis(4′-methyl-2,2′-bipyridyl-4-yl)ethane, and bphb=1,4-bis(p′-methyl-2,2′-bipyridyl-4-yl)benzene] were reported to have life times τₑₘ=1.31 and 1.57 μs, respectively, which are longer than 0.95 μs for the mononuclear RU(dmb)₃²⁺ system. In terms of emission quantum efficiency (φₑₘ) the bimetallic species [(dmb)₂Ru]₂(bphb)⁴⁺ has (φₑₘ)=0.125 whereas the monometallic (dmb)₂RU(bphb)²⁺ was 0.109. Based on these results, Bard et al (WO 99/00462) has recently performed ECL in these systems and found that the ECL efficiencies can be enhanced by a factor 2 to 3 in both acetonitrile and aqueous media. However, using these compounds as labeling species is problematic since there is no possibility of introducing a linker that couples the label to analyte without changing the identity of one or both Ru units. As a matter of fact WO 99/00462 contains no example of bio-conjugatable bimetallic compound.

The concept of enhancing ECL signals by increasing the number of signal producing molecules has been previously proposed. The Oprandy U.S. Pat. No. 5,679,519 discloses a multi-labeled probe complex comprising a biotinylated bovine serum albumin (BSA) platform molecule attached by a plurality of electrochemiluminescent labels.

An object of the present invention is to provide novel dendritic, bio-conjugatable supramolecular metal complexes defined by a bio-linker, a dendritic chemical platform and multiple, identical, non-interacting luminophores connected to the platform with or without spacers.

Another object of the invention is to provide dendritic, polynuclear metal complexes which, when used as labels for bioanalytical assays enhance signal intensity and reduce non-specific binding and thus increase signal-to-noise.

General Description of the Invention

Accordingly, the present invention relates to a supramolecular assembly having the formula
[B][P][S]ₘ[M(L′)(L″)(L′″]ₙA₀
wherein:
B is an active chemical moiety covalently linked to a platform P or one of ligands L′, L″ and L′″ and has a bio-conjugatable group at the free ends thereof;
P is a platform that can accommodate multiple luminophors;
S is a spacer that covalently bridges P and one of the ligands L′, L″, and L′″ and prevents multiple metal complexes from steric constraints;
M is a metal cation
L′, L″, and L′″ are ligands of M which may be the same or different from each other; at least one of the ligands being connected to the spacer S, or the platform P;
A is an anion
m is zero or equal to n;
n is an integer equal to or greater than 2; and
o is an integer equal to or greater than 2.

An example of the bio-conjugatable, group B is N-hydroxysuccinimide ester. The platform may be as simple as a single C, Si or N atom, or a multi-atom block such as a multi-substituted benzene ring or a dendritic assembly. The spacer may be an atom or a multi-atom block, and in some cases may be integral with the platform P. The metal cation M is preferably ruthenium but can also be osmium, rhenium or lanthanide. The ligands L′, L″ and L′″ are organic compounds that share their electrons with the metal atom M to form metal complexes. The ligands are N—N chelating compounds such as derivatives of 2,2′-pyridine, 2,2′-6,2″-terpyridine and 1,10-phenanthroline. Preferably the ligands are derivatives of 2,2′-bipyridine. Suitable anions include PF₆⁻, BF₄⁻]and Cl⁻, PF₆⁻ being preferred. The luminophor is the metal complex M(L′)(L″)(L′″), one of the ligands L (L′, L″ or L′″) of which is covalently connected either to the spacer S or directly to the platform P and emits electromagnetic radiation upon exposure to electrochemical energy under specific conditions. The luminophors defined in this invention are redox active, i.e., under the electrochemical condition, the luminophors undergo oxidation and reduction on the electrode.

### BRIEF DESCRIPTION OF THE DRAWINGS

The invention is described below in greater detail with reference to the accompanying drawings, wherein:

FIG. 1, which is mentioned above, is a schematic illustration of multilabeling biomolecules (here, an antibody) at a single site with a dendritic label for the analysis of an antigen in sandwich assay;

FIG. 2 is a schematic diagram of the structure of a dendritic multilabeling reagent;

FIG. 3 is the spiderweb formula of an exemplary multilabeling organametallic complex in accordance with the present invention;

FIG. 4 shows absorption and emission spectra of the complex of FIG. 3;

FIG. 5 is a cyclic voltammogram of the complex of FIG. 3;

FIG. 6 is a graphic illustration of the process for preparing the complex of FIG. 3;

FIG. 7 is a matrix assisted laser desorption ionization time-of-flight or (MALDI-TOF) mass spectrum of rutherium labeled BSA; and

FIG. 8 shows plots of ECL emission intensity as a function of time for complexes in accordance with the present invention.

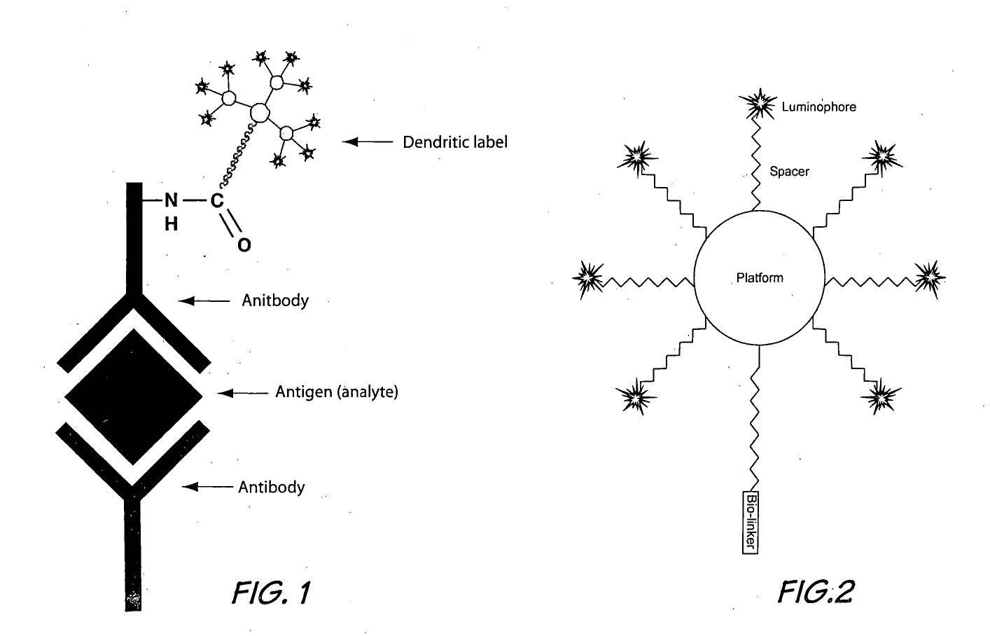

### DESCRIPTION OF THE PREFERRED EMBODIMENT

In the present invention, therefore, a class of supramolecules with a plurality of identical, noninteracting luminophors is employed as ECL labels. Each of the luminescent and redox active moieties can be electrochemically excited and emit electromagnetic radiation independently. Another important feature of the label species is the deridritic or tree-like structure, in which the identical metal containing redox luminophors are the terminal moieties of each branch.

Differing from the multi-labeled BSA complex described in the Oprandy U.S. Pat. No. 5,679,519, the dendritic supramolecular luminescent labels of the invention are substantially chemical species based on the recent achievements of synthetic chemistry and supramolecular chemistry. Application of the dendritic supramolecular polymetallic species as luminescent labels is actually the same as the conventional ECL labeling with [Ru(bpy)₃-NHS ester]²⁺ species.

Dendrimers are structurally unique, highly branched meso- and macromolecules, whose aesthetic architectures can be easily envisioned, but are nearly unnamable according to current chemical nomenclature systems. Quite a few descriptive names have been used to give generally the structural characteristics, such as: arborols, cascade molecules, cascadol, cauliflower polymers, crowned arborols, dendritic polymers, highly branches polymers, hyperbranched nanosized molecules, molecular fractals, polycules, silvanols, star polymers, starburst dendrimers, starburst polymers, tree-like polymers, etc. Unlike many other synthetic macromolecules, dendrimers possess a high degree of structural order. Well-developed dendrimer synthesis routes provide perfect control over molecular weight, topology and functionalization at the periphery. A complete dendrimer comprises a core moiety, repeating or branch units, and peripheral or terminal moieties.

The dendritic supramolecular polymetallic species of the invention are dendrimers bearing metal complex luminophors as peripheral functionalization moieties. Peripheral functionalization prevents the interaction between metal complex luminophbrs and provides easy access for the co-reactants. In some cases, the big size of the metal complexes hinders them from being directly linked to the functional sites on the repeating units, therefore spacers must be placed between complexes and the repeating units to prevent steric hindrance. Furthermore, to be coupled with an analyte, a bio-linker must be added, either to the core or to one of the peripheral moieties. Thus, the general structure of the dendritic metal complex labels of the invention is illustrated in FIG. 2 and can be formulated as described above.

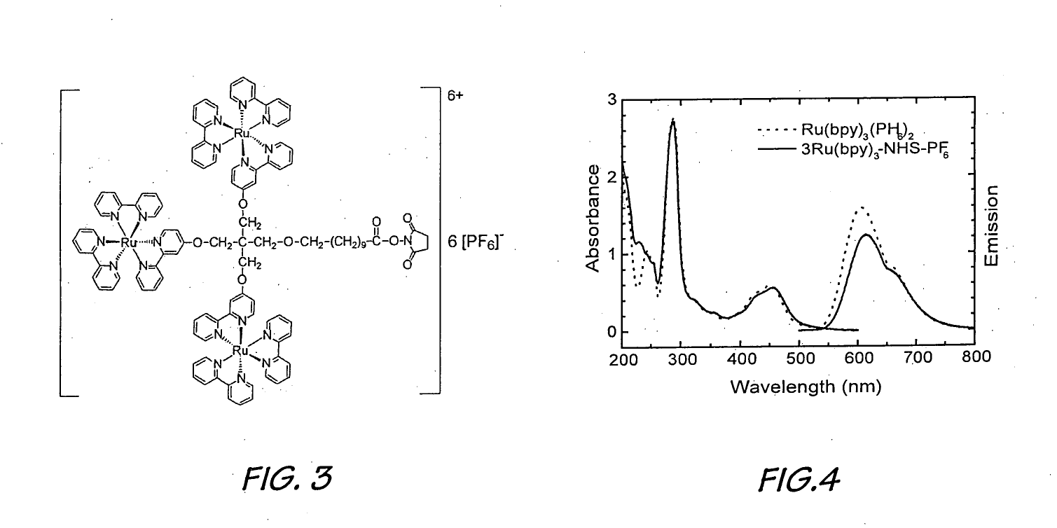

The structure of one of the simplest dendritic polynuclear labeling reagents in accordance with the present invention is shown in FIG. 3. This is a zero generation dendrimer with a bio-linker (succinimidyl group), a platform (C atom), three spacers (CH₂—O—) and three peripheral Ru(bpy)₃²⁺ moieties. When excited, either photochemically or electrochemically in solution, the species generates luminescence of 613 nm, indicating the independence of three peripheral RU(bpy)₃²⁺ moieties.

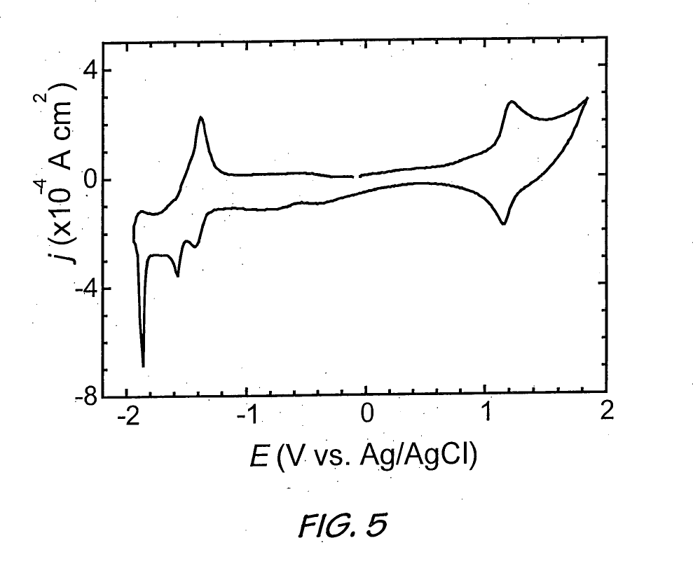

The absorption and emission spectra of the compound of FIG. 3 is shown in FIG. 4. The spectra of both Ru(bpy)₃ (PF₆)₂ and 3 Ru(bpy)₃—NHS—PF₆ were recorded in acetonitrile at 2930° K. The Ru-unit concentration is 40 μM for both compounds. The cyclic voltammogram of the compound of FIG. 3 is shown in FIG. 5. The voltammogram of 3 Ru(bpy)₃-NHS—PF₆ (0.234 mM) was taken in acetonitrole at 293° K. The supporting electrolyte was 0.1 M tetrabutylammonium hexafluorophosphate. The scan rate was 100 mVs⁻¹. The original potentials versus Ag quasi-reference electrode were calibrated with the ferrocence/ferrocenium redox couple (0.35 V vs Ag/AgCl).

In the methods described in the following examples, for synthesis, reagent grade solvents and reactants were used as received unless otherwise specified. For characterization, Ru(bpy)₃Cl₂.6H₂O (Aldrich), tetrabutylammonium hexafluorophosphate (TBAPF₆, Fluka, electrochemical grade),tri-n-propylamine (TPA, 99+%, Aldrich), bovine serum albumiri (BSA, lyophilized powder, Sigma), anhydrous acetonitrile (Aldrich), phosphate buffered saline (PBS, in the form of tablets for preparing solution of pH=7.4, Sigma) and deionized water (18 MΩ) were used as received.

### EXAMPLES

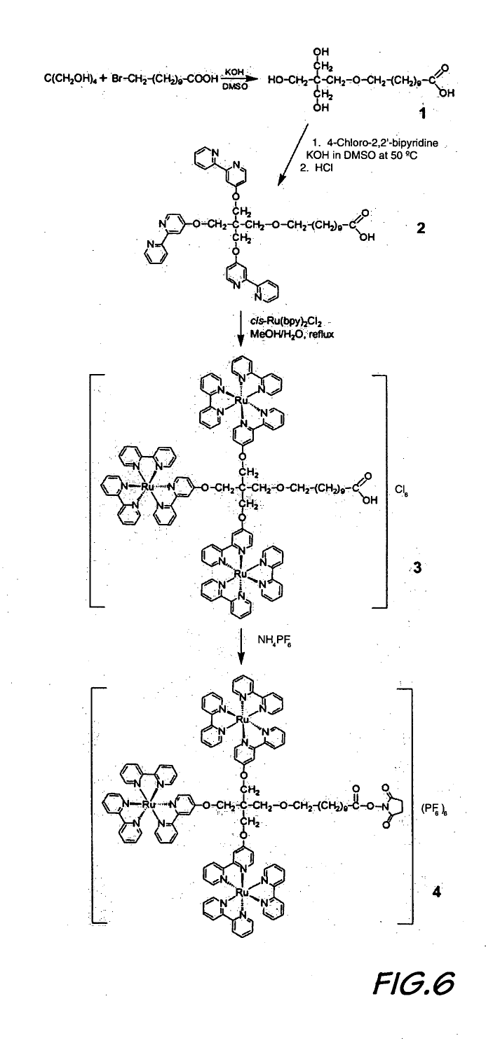

For the following syntheses, reference is made to the reaction scheme of FIG. 6.

### Example 1

Synthesis of Compound 1.

7.5 g (5.51×10⁻² mol) of pentaerythritol and 3 g of KOH were stirred in 15 mL of DMSO for 15 min. 1.5 g (5.66×10⁻³ mol) of 11-bromoundecanoic acid was dissolved in 5 mL of DMSO and added in 8 portions to the pentaerythritol/KOH mixture in a period of 8 hrs. (1 portion/hr). The reaction mixture was continuously stirred under argon at room temperature for 14 hrs (total 22 hrs). The oil-like liquid was poured into 150 mL of water and the solution was acidified with 1 N HCl to pH 1-2. The precipitate was filtered, washed and dried to yield 1.38 g of white powder (yield 76%) ¹H NMR (400 MHz, acetone-d₆) δ 10.4 (b,1 H), 3.62 (s, 6 H, 3 CH₂O), 3.46 (s, 2 H, CH₂O), 3.40 (t, 2 H, OCH₂), 2.28 (t, 2 H, CH₂), 1.59 (q, 2H, CH₂), 1.54 (q,2 H, CH₂), 1.32 (b, 12 H, 6 CH₂).

Synthesis of Compound 2

0.303 g (9.45×10⁻⁴ mol) of compound 1 and 2 g of KOH were stirred in 10 mL of DMSO for 10 min. 0.645 g (3.38×10⁻³) of 4-chloro-2,2′-bipyridine was added. The reaction mixture was continuously stirred under argon at 50° C. for 22 hrs. After reaction, the mixture was poured into 30 mL of water. Extraction with 100 mL of CH₂Cl₂ was tried when the solution was highly alkaline but it was found difficult to separate the two phases. After evaporation of CH₂Cl₂, the oil was purified by chromatography (silica gel treated with 20% triethylamine in hexane, elution 5-10% methanol in CH₂Cl₂ and pure methanol) and vacuum dried to afford a sticky transparent product. This was dissolved in methanol and precipitated in acidified water to yield 52 mg of white powder. The remaining water phase was adjusted to pH=8 with NH₃H₂O. The solution was further extracted with CH₂Cl₂ until no more bipyridine derivatives could be detected by TLC. After evaporation of CH₂Cl₂, the oil was purified by chromatography (silica gel treated with 20% triethylamine in hexane, elution 5-10% methanol in CH₂Cl₂, and pure methanol), vacuum dried and precipitated in acidified water to yield 223 mg of product.

The yield for the combined product is 37%. ¹H NMR (400 MHz, CDCl₃) δ 8.63 (d, 3 H), 8.45 (d, 3H), 8.32 (d, 3 H), 7.4-8.2 (b, 4 H, NH₄), 7.97 (d, 3 H), 7.76 (t,3 H), 7.26 (t, 3 H), 6.84 (dd, 3 H), 4.39 (s, 6 H, 3 CH₂O), 3.72 (s, 2 H, CH₂O), 3.38 (t,2 H, OCH₂), 2.20 (t, 2 H, CH₂), 1.53 (q, 2 H, CH₂), 1.45. (q, 2 H, CH₂), 1.0-1.2 (b, 12 H, 6 CH₂).

Synthesis of Compound 3

0.102 g of compound 2, (1.275×10⁻⁴) mol and 0.252 g (4.843×10⁻⁴ mol) of cis-Ru(bpy)₂Cl₂.2H₂O were mixed with 10 mL of methanol and 3 mL of water and refluxed under nitrogen for 24 hrs. After cooling to room temperature, the solution was roto-evaporated. The remaining solid was dissolved in 10 mL of water and filtered to remove unreacted cis-Ru(bpy)₂Cl₂. The filtrate was roto-evaporated and redissolved in 20 mL of water. Three drops of concentrated HCl were added and the solution was left overnight. The water was roto-evaporated and the acidification process was repeated with three drops of concentrated HCl in 5 mL of water. The solution was again filtered, roto-evaporated and dried to afford 0.262 g of dark brown solid compound 3-Cl (yield 92%).

The remaining small amount of unreacted cis-Ru(bpy)₂Cl₂ was further washed out by CH₂Cl₂. 3-PF₆ was prepared by adding a large excess of saturated NH₄PF₆/water solution to compound 3-Cl water solution. The orange precipitate was filtered, washed with water and dried. The dried solid was redissolved in acetonitrile and treated with 60% HPF₆ aqueous solution and then precipitated in dry diethyl ether. After centrifugal separation and vacuum drying, very pure compound 3-PF₆ was obtained. ¹H NMR (400 MHz, acetonitrile-d₃) δ 8.59 (d, 3 H), 8.49 (d, 12H), 8.16 (s, 3 H), 8.04 (m, 15 H), 7.77 (d, 3 H), 7.72 (m, 12 H), 7.46 (d,3 H), 7.38 (m, 15 H), 6.98 (d, 3 H), 4.46 (s, 6 H, 3 CH₂O), 3.71 (s, 2 H, CH₂O), 3.35 (t, 2 H, OCH₂), 2.13 (t, 2 H, CH₂),1.35 (m, 4 H, 2 CH₂), 0.95-1.15 (b m, 12 H, 6 CH₂).

Pure compound 3-Cl was prepared by replacing PF₆ with Cl⁻. The preparation was carried out by adding an excess of tetrabutylammonium chloride saturated in acetone to the acetone solution of compound 3-PF₆, followed by acidification with hydrochloric acid, filtration and vacuum drying. ¹H NMR (400 MHz, acetonitrile-d₃) δ 9.19 (d, 3 H), 8.80 (m, 3 H), 8.62 (d m, 12 H), 8.05 (m, 15 H), 7.78 (m, 3 H), 7.70 (m, 12 H), 7.45 (d, 3 H), 7.38 (m 15 H), 7.05 (d, 3 H), 4.62 (s, 6 H, 3 CH₂O), 3.71 (s, 2 H, CH₂O), 3.40 (t, 2 H, OCH₂), 2.19 (t, 2 H, CH₂), 1.34 (m, 2 H, CH₂), 1.28 (m, 2 H, CH₂), 0.90-1.10 (b m, 12 H, 6 CH₂). ¹H NMR (400 MHz, D₂O) δ 8.52 (m, 15 H), 8.25 (m, 3 H), 7.98 (m, 15 H), 7.53-7.80 (m, 18 H), 7.15-7.40 (m, 15 H), 7.06 (m, 3 H), 4.50 (m, 6 H, 3 CH₂O), 3.70 (m, 2 H, CH₂O), 3.39 (t, 2 H, OCH₂), 1.90 (t, 2 H, CH₂), 1.29 (b, 2 H, CH₂), 0.82 (b, 4 H, 2 CH₂), 0.71 (b,2 H, CH₂), 0.52 (b, 4 H, 2 CH₂), 0.38 (b, 2 H, CH₂), 0.23 (b, 2 H, CH₂).

### Example 2

Synthesis of Compound 4-PF₆.

N,N-Dicyclohexylcarbodiimide (DCC, 2.31 mg, 1.10×10⁻⁵ mol) and N-hydroxysuccinimide (NHS, 1.36 mg, 1.15×10⁻⁵ mol) were mixed with 3-PF₆ (16.1 mg, 5.56×10⁻⁶ mol) in 0.4 mL of acetonitrile and stirred overnight at room temperature. The reaction mixture was injected into 10 mL of dry diethyl ether through a 0.2 μm syringe filter. The orange precipitate was collected by centrifuging and vacuum dried to afford 11.2 mg of product (yield 67%). ¹H NMR (400 MHz, acetonitrile-d₃) δ 8.68 (d, 3 H), 8.48 (d, 12 H), 8.25 (s, 3 H), 8.04 (m, 15H), 7.77 (d, 3 H), 7.72 (m, 12 H), 7.45 (d, 3 H), 7.37 (m, 15 H), 6.96 (d, 3H), 4.47 (s, 6 H, 3 CH₂O), 3.70 (s, 2 H, CH₂O), 3.35 (t, 2 H, OCH₂), 2.76 (s, 4 H), 2.48 (t, 2 H, CH₂), 1.46 (q, 2 H, CH₂), 1.35 (q, 2 H CH₂), 0.9-1.2 (b m, 12 H, 6 CH₂).

Labeling of Protein.

Protein labeling experiments were carried out by using BSA as a model protein, which is commonly employed as a protein standard in bioanalytical assays and as a molecular weight standard (66431 Da⁹) for gel permeation chromatography. BSA contains 59 Iysines, and 30-35 of these are primary amines capable of reacting with the succinimidyl conjugation group (see G. T. Hermanson, Bioconjugate Techniques; Academic Press: San Diego, 1996; p. 423). It should be noted that the chlorides of compounds 3, 4 and 6 are very soluble in water. However, due to the generally possible slow hydrolysis of NHS ester in aqueous solutions, 4-PF6 was used instead of the water soluble compound 4-Cl, to prepare stock solution for labeling experiment. Like other hexafluorophosphate salts, 4-PF₆ is very soluble in polar organic solvents such as acetone, acetonitrile, methanol, DMF and DMSO, but insoluble in water.

The UV-vis absorption of the labeled BSA in PBS solution has the ligand centered transition absorption at 286 nm and the MLCT absorption at 458 nm, which is slightly red-shifted with respect to its MLCT absorption band in acetonitrile. The average number of [Ru(bpy)₃]²⁺ units attached to a BSA molecule was determined by the absorbance peaks at 286 and 458 nm, assuming the extinction coefficients for the free and BSA-bound trinuclear assemblies are the same. Compound 3-Cl (extinction coefficients in PBS based on Ru-unit are ε²⁸⁶=57400 M⁻¹ cm⁻¹) was used as a reference in PBS. In one labeling experiment with the initial molar ratio of 4-PF₆ to BSA set as 5.1:1, it was found that on average four triads, i.e. twelve [Ru(bpy)₃]²⁺ units were bound to a BSA molecule.

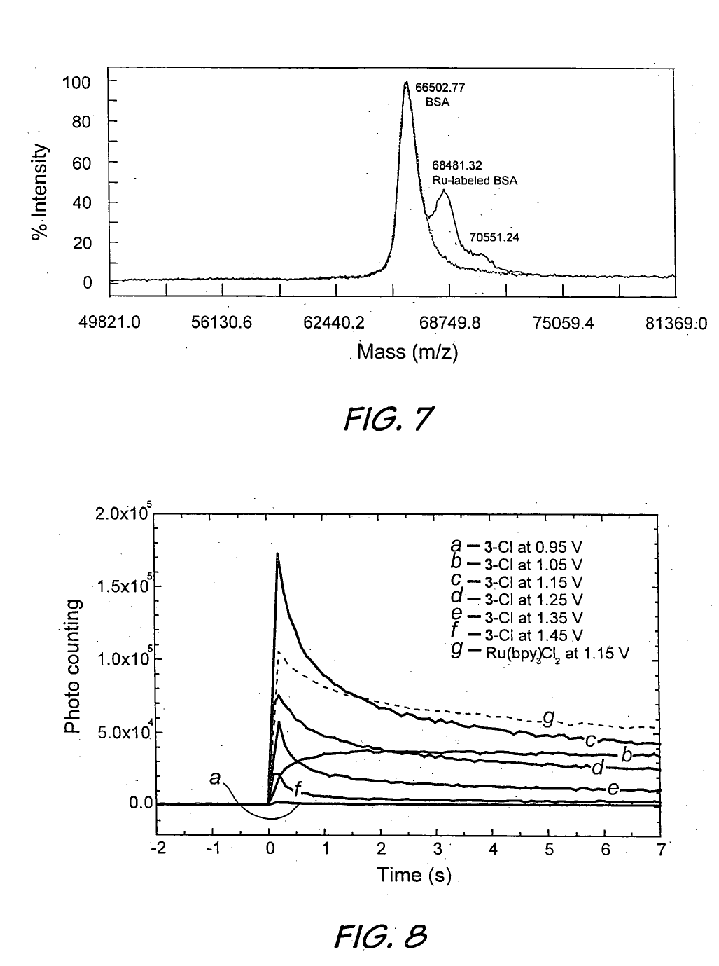

The binding of the prototype label to the BSA and the number of bound [Ru(bpy)₃]²⁺ units were further comfirmed by MALDI-TOF mass spectrum. The mass spectra in FIG. 7 demonstrates the BSA triply labeled with [Ru(bpy)₃]²⁺ at a single site. Compared to the measured BSA mass of 66503 Da, the peak with n/z at 68481 Da indicates the labeled BSA has a mass increase of about 1978 Da, which—assuming that all six PF₆ moieties were lost during the ionizaton process, is in excellent agreement with the calculated value of 2005.25 Da within the general mass error of 0.5% for protein MALDI-TOF mass spectra. For the purpose of internal reference in FIG. 7, the BSA used for labeling was in excess (the molar ratio of BSA to 4-PF₆ was 1.2:1). However, a shoulder at about 70551 Da (4048 Da shift from 66503 Da0 is apparent, indicative of a small amount of BSA labeled with two [Ru(bpy)₃]²⁺ triads, i.e., six [Ru(bpy)₃]²⁺ units (calculated mass increase 4010.50 Da, assuming twelve PF₆ moieties lost). The mass spectrum of the pristine BSA is also exhibited in FIG. 7, showing a single peak at 66503 Da and ruling out any concern about the existence of impurities in the displayed mass scale. The MALDI-TOF mass spectra in FIG. 7 represents a direct and clear evidence for the successful multilabeling with [Ru(bpy)₃]²⁺ triad at a single site of a protein molecule.

As mentioned above, FIG. 8 shows plots of the intensity of ECL emission maximum as a function of time and applied potential for 3-Cl and Ru(bpy)₃Cl₂. The solutions used were 0.275 mM or 0.825 mM Ru-unit for 3-Cl and 0.865 mM for Ru(bpy)₃Cl₂ in TPA saturated PBS (pH=˜9). The reference electrode was Ag/AgCl, and background photon counting: <1000.

In summary for the purpose of multilabling biomolecules at a single site in bioanalytical science, a dendritic prototype label with three [Ru(bpy)₃]²⁺ linked to a succinimidyl group was synthesized and characterized by structural, photophysical and electrochemical methods. The confirmed independence of each [Ru(bpy)₃]²⁺ unit, the covalent attachment of the trinuclear [Ru(bpy)₃]²⁺ assembly to BSA in PBS and the generation of ECL in tripropylamine containing aqueous buffer solution substantiate the applicability of the novel miltilabeling strategy to the established ECL assays.

1. A dendritic supramolecular compound comprising:
an active chemical moiety having a bio-conjugatable group at free ends thereof, said chemical moiety being covalently linked to a platform that can accommodate multiple luminophors or to one of a plurality of ligands;
a plurality of metallic luminophors as terminal moieties; and
a plurality of counterions sufficient to balance the electronic charge of said metallic luminophors.

2. The supramolecular compound of claim 1, wherein said live-conjugatable groups is N-hydroxysuccinimide ester and said luminophors are Ru(bpg)₃²⁺ moieties.

3. A dendritic supramolecular compound having the formula
[B][P][S]ₘ[M (L′)(L″)(L′″]ₙA₀
wherein:
B is an active chemical bio-linker covalently linked to a platform P or one of ligands L′, L″ and L′″ and has a bio-conjugatable group at the free ends thereof;
P is a platform that can accommodate4 multiple metallic complex luminophors;
S is a spacer that covalently bridges P and one of the ligands L′, L″, and L′″ and prevents multiple metal complexes from steric constraints;
M is a metal cation
L′, L″, and L′″ are ligands of M which may be the same or different from each other; at least one of the ligands being connected to the spacer S, or the platform P;
A is an anion
m is zero or equal to n;
n is an integer equal to or greater than 2; and
o is an integer equal to or greater than 2.

4. The supramolecular compound of claim 1, wherein the active chemical moiety B is N-hydroxysuccinimide ester;
the platform P is C, Si, N, P or a dendritic moiety;
the spacer is an atom or multi-atom block;
the metal cation M is a ruthenium, osminum, rhenium or lanthanide; and
the anion A is PF₆⁻, BF₄⁻ or Cl⁻.

5. A supramolecular compound of the formula

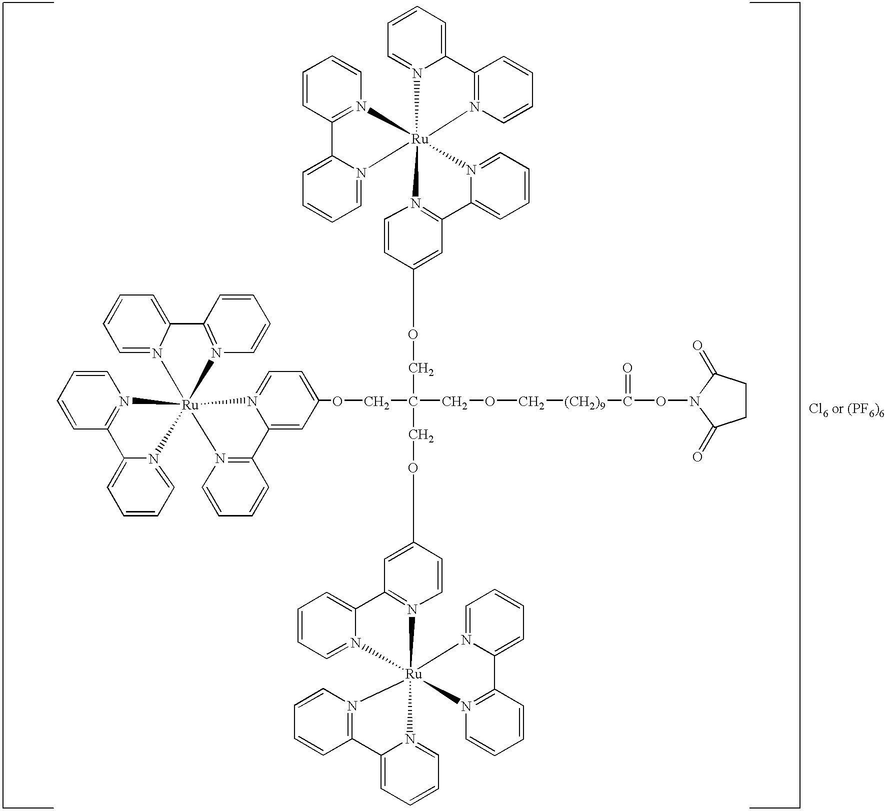

6. A process for preparing supramolecular compound of the formula 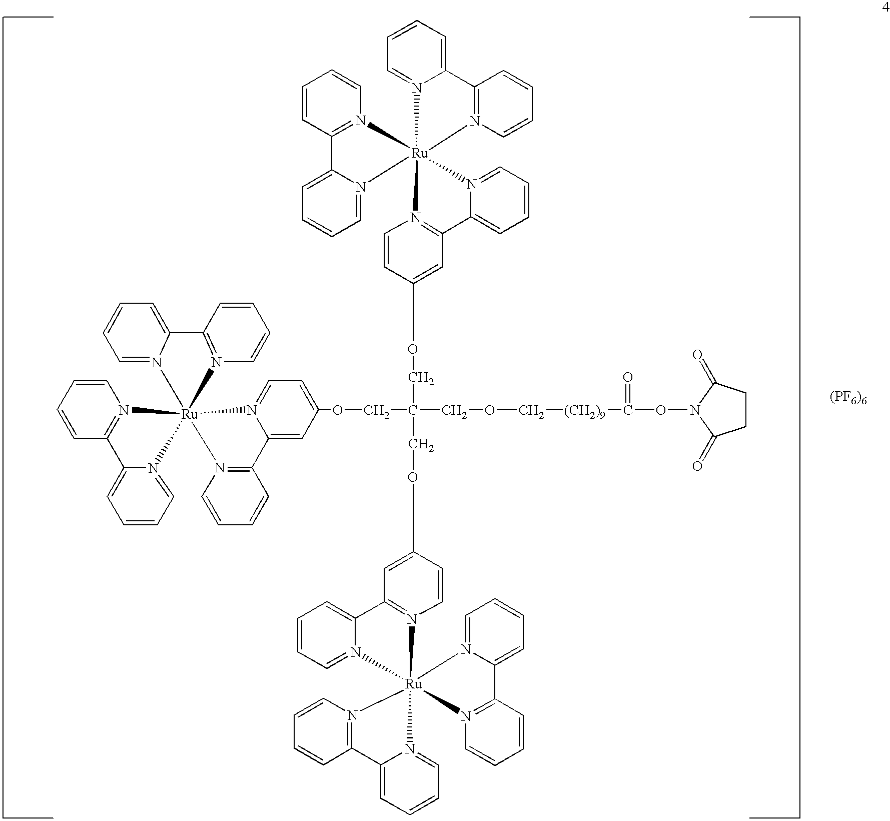
comprising the steps of
(a) reacting pentaerythritol with 11-bromoundecanoic acid to produce a compound of the formula 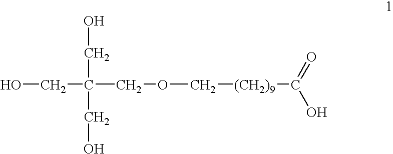
(b) reacting the compound of the formula 1 with 4-chloro-2,2′-bipyridine to produce a compound of the formula 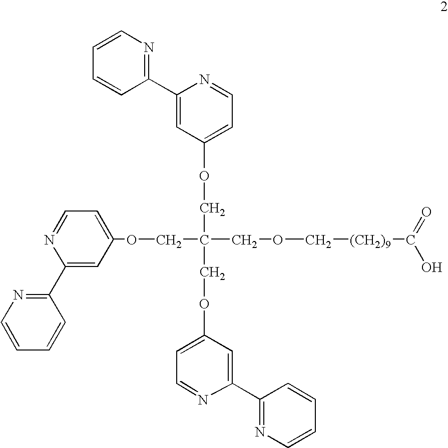
(c) reacting the compound of the formula 2 with cis-ruthenium-bipyridyl chloride to yield a compound of the formula 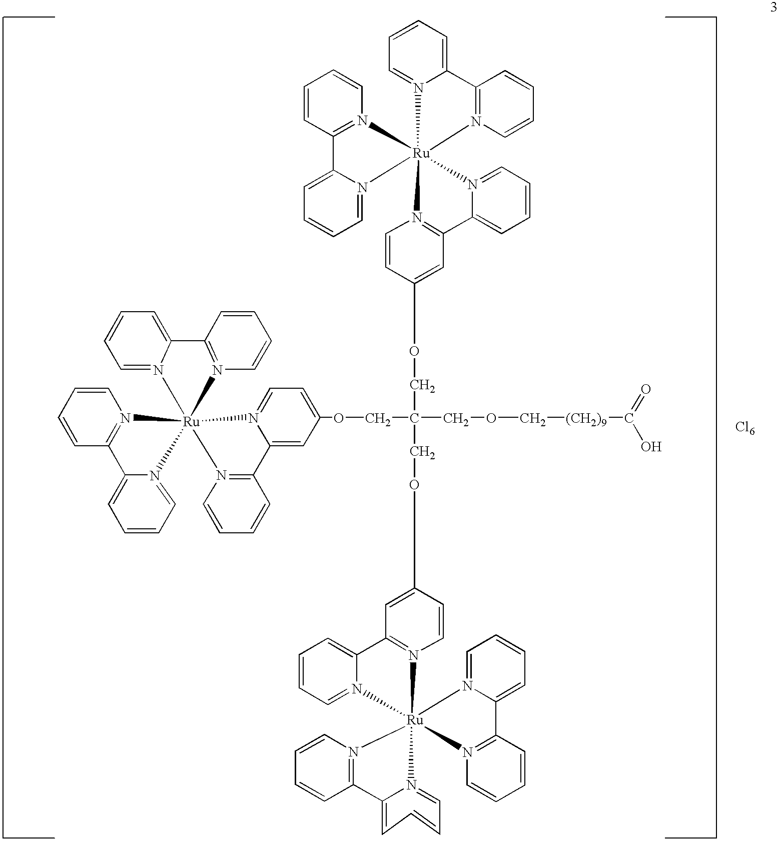
(d) precipitating the compound of the formula 3 with ammonium hexafluorophosphate.

7. The process of claim 6 wherein the compound of the formula 4 is reacted with tetrabutylammonium chloride followed by acidification with hydrochloric acid to yield a pure compound of the formula 3.

8. The use of the compound of claim 1 for effecting an electrochemiluminescence-based bioanalytical assay.

9. The use of the compound of claim 3 for effecting an electrochemiluminescence-based bioanalytical assay.
